(19) United States
(12) Patent Application Publication
(10) Pub. No.: US 2010/0238127 A1
(43) Pub. Date: Sep. 23, 2010

(54) SYSTEM COMPRISING A LIGHTING CONTROL CONSOLE AND A SIMULATION COMPUTER

(75) Inventors: Michael Adenau, Wurzburg (DE); Hartmut Cordes, Bremen (DE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: MA Lighting Technology GmbH, Waldbuttelbrunn (DE)

(21) Appl. No.: 12/467,685

(22) Filed: May 18, 2009

Related U.S. Application Data
(63) Continuation-in-part of application No. 12/409,197, filed on Mar. 23, 2009.

(51) Int. Cl. G06F 3/033

(52) U.S. Cl. 345/173; 345/184

(57) ABSTRACT

The invention relates to a system (01) comprising a lighting control console (02) for controlling a lighting system, and an external simulation computer (03), wherein digital adjusting commands that can be transmitted to the lighting devices of the lighting system via data links are generated in the lighting control console (02), and wherein the lighting control console (02) includes at least one housing, in which the hardware components are disposed for protection from external influences, and wherein the lighting control console (02) includes multiple operating elements (06, 07, 08), particularly keys (06), slide controllers (07), and/or rotary controllers (08), which elements are arranged on the top of the housing and can be used for entering operating commands, and wherein the lighting control console (02) includes at least one display device (09, 10, 11, 12), and wherein the external simulation computer (03) is connected to the lighting control console (02) via a data link, and wherein the simulation computer (03) includes at least a housing, in which the hardware components are disposed for protection from external influences, and wherein a three-dimensional simulation of a light show that is controlled by the lighting control console can be calculated on a virtual stage in the simulation computer (03), and wherein a display device (05) on which the simulation of the light show can be displayed is connected to the simulation computer, and wherein the lighting control console (02) and simulation computer (03) are connected to each other via an input data line (04), wherein operating commands entered at a control element (06, 07, 08) of the lighting control console (02) can be transmitted to the simulation computer (03) via the input data line (04) for controlling the simulation.

The invention relates to a system comprising a lighting control console for controlling a lighting system, and an external simulation computer connected thereto for calculating a three-dimensional simulation of a light show as recited in the preamble of claim 1.

Known lighting control consoles are used for controlling lighting systems such as are used, for example, in theaters and/or on concert hall stages. These lighting systems normally include a large number of lighting devices, stage spotlights for example, wherein for their part, the lighting devices alone can be switched among a wide range of lighting states, for example different colors. The various lighting devices with their different lighting states are controlled by programmable parameters in the lighting program of the lighting control console.

Conventional lighting systems may include as many as several thousand lighting devices. The lighting control consoles provided for controlling the lighting devices typically include a housing that accommodates and protects the electronic hardware components necessary for the function from external influences. A microcontroller, for example a complex digital processor that enables digital data and signal processing, is typically present in the housing to control the complex lighting systems. Control elements, such as keys, slide controllers and/or rotary controllers, are also provided on the housing to enable operating commands to be input. The lighting control console is typically furnished with display devices as well, for example color monitors, so that user data can be displayed.

Programming a light show can be extremely time-consuming, since many parameters have to be set. In order to reduce the costs of programming light shows, its is known from the related art to simulate the light show first and to display the desired effects on a display device in the form of a virtual light show simulation. In this way, the rough preliminary work can be carried out when the light show is programmed, without using the actual stage, which results in considerable cost savings. In systems according to the invention, simulation computers are used to calculate the three-dimensional simulation of the light show, and the hardware in such computers must be capable of very high computing power in order to be able to carry out the calculations required to run the simulation within an acceptable period of time. The simulation computer is installed together with its hardware in its own housing, separately from the lighting control console. The advantage of this is that the simulation computer is able to be replaced very easily, for example when an older simulation computer has to be replaced with a new simulation computer having even more powerful hardware. For the purposes of data, the lighting control console and the simulation computer in the system are connected via data links, so that data may be transmitted between the lighting control console and the simulation computer.

In the known systems comprising a lighting control console and a simulation computer, dedicated input devices, for example a computer keyboard or a computer mouse, are provided to enable input commands to be entered in the simulation computer. In other words, this means that the control elements on the lighting control console must be used to input operating commands into the lighting control console, and the control elements on the simulation computer must be used to input operating commands into simulation computer. This arrangement whereby input commands are entered separately into the lighting control console on the one hand and into the simulation computer on the other hand is a major disadvantage in terms of operating convenience, since the user is required to switch between the different input devices for each.

Based on the existing art, the object of the present invention is therefore to suggest a novel system comprising a lighting control console and a simulation computer in which user convenience is improved.

This object is achieved with a system according to the teaching of claim 1.

Advantageous embodiments of the invention are the object of the subordinate claims.

The system according to the invention, comprising a lighting control console and a simulation computer, relies on the basic idea of providing at least one input data line between the lighting control console and the simulation computer to connect the lighting control console to the simulation computer. This input data line serves to transmit data the user has entered with the control elements on the lighting control console to the simulation computer. As a result, this makes it possible to control the simulation computer by entering operating commands with the control elements on the lighting control console. Separate control elements for controlling the simulation computer directly are thus no longer needed, since both the lighting control console itself and the simulation computer may be controlled by entering operating commands with the control elements on the lighting control console. Consequently, the control elements on the lighting control console serve a dual purpose, that of controlling both the lighting control console and also the simulation computer. The requisite data transmission takes place via the input data line between the lighting control console and the simulation computer.

In general, any control elements may be provided on the lighting control console for controlling the simulation computer. According to a preferred embodiment of the invention, the lighting control console is equipped with a touch-sensitive sensing face, and touching the touch-sensitive sensing face in the area of a contact surface may cause an operator input assigned to the respective contact surface to be selected and transmitted to the simulation computer as an operating command. This type of touch-screen control helps to increase convenience considerably for users who are programming and controlling the simulation computer.

It is also particularly advantageous if multiple simultaneous touches of contact surfaces are able to be detected at the sensing face of the display unit and to be transmitted together to the simulation computer as an operator input. Multi-touch input commands of such kind enable a completely new operating concept for programming and controlling the simulation computer.

The use of a touch-sensitive display unit enables either keys and/or slide controllers and/or rotary controllers to be introduced as control elements for controlling and programming the simulation computer.

In many cases, the lighting control console itself is also equipped with an internal simulation computer for calculating a three-dimensional simulation of the light show that is to be controlled by the lighting control console. If this is the case, the internal simulation computer in the housing of the lighting control console should be capable of exchanging data with the external simulation computer via a data line, so that it is possible to synchronize the two simulation computers.

The basis for calculating the light show simulation is the configuration of the lighting devices in the actual lighting system. This configuration may be described by configuration data in a configuration file. In order to enable the data be administered consistently, the configuration file in the lighting control console that describes the configuration of the actual lighting system should be connected to the external simulation computer via a data line. In this way, it becomes possible to transmit the configuration data from the configuration file to the simulation computer for calculating the light show that is controlled by the lighting control console, for analysis and use by the computer.

In general, the configuration file may contain any configuration data. According to a preferred embodiment, the configuration file contains configuration data for describing the arrangement of the lighting devices on the stage.

Alternatively or additionally, the configuration file may also contain configuration data for describing the function parameters of the lighting device and/or configuration data for describing three-dimensional objects on the stage, stage props, for example.

An embodiment of the invention is shown in diagrammatic form in the drawing and will be explained for exemplary purposes in the following.

In the drawing:

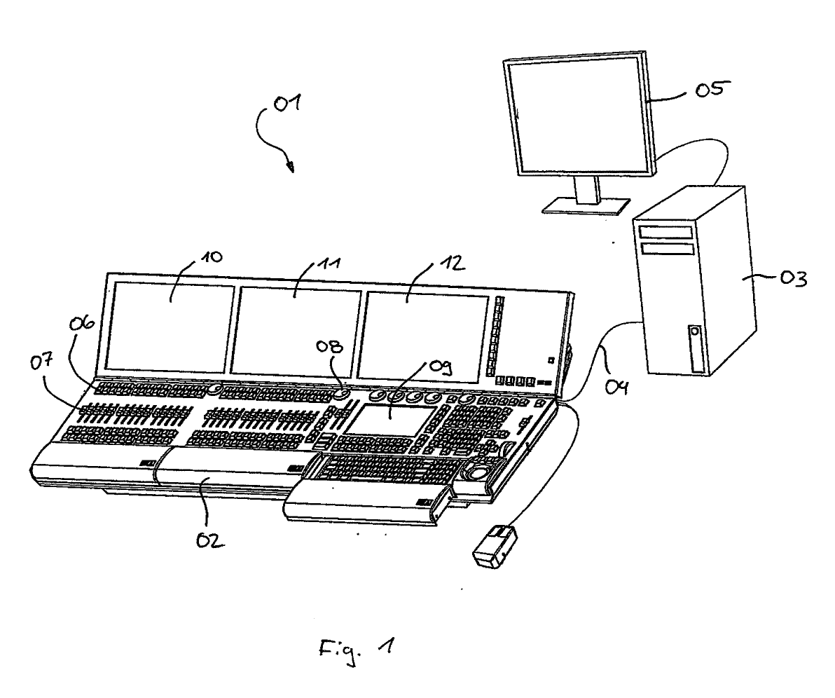

FIG. 1 is a perspective view of a system comprising a lighting control console and a simulation computer.

FIG. 1 shows a system 01 comprising a lighting control console 02 and a simulation computer 03. The lighting control console 02 and the simulation computer 03 are connected to each other via in input data line 04 and are thus able to exchange data. A display device 05, for example a color display, is also connected to the simulation computer 03, so that the light show simulation calculated on the simulation computer 03 may be displayed.

The lighting control console 02 is equipped with a plurality of control elements, keys 06, slide controllers 07 and rotary controllers 08 to enable the user to enter operating commands. The operating commands entered via the control elements 06, 07 and 08 may serve either to control and program the lighting control console 02 directly or to control and program the simulation computer 03. If the operating commands entered via the control elements 06, 07 and 08 are used for controlling and programming the simulation computer 03, the corresponding input data is transmitted from the lighting control console 02 to the simulation computer 03 via the input data line 04. In order to make it still easier to enter operating commands, the lighting control console 02 is also equipped with a touch-sensitive display device 09. Operating commands may be entered via this touch-sensitive display device 09 by touching the touch-sensitive display device 09. Three further display devices 10, 11 and 12 are also present on the lighting control console 02 for displaying operating menus.

1-11. (canceled)

12. A system comprising:
a lighting control console for controlling a lighting system comprising:
at least one housing in which hardware components are disposed for protection from external influences, and
multiple operating elements including one or more keys, slide controllers or rotary controllers, wherein the operating elements are arranged on the top of the housing and can be used for entering operating commands, and
at least one display device, and
an external simulation computer comprising at least a housing in which hardware components are disposed for protection from external influences, wherein the external simulation computer is connected to the lighting control console via an input data line, wherein operating commands entered at a control element of the lighting control console can be transmitted to the simulation computer via the input data line for controlling a simulation; and
a display device connected to the simulation computer on which the simulation of the light show can be displayed;
wherein digital adjusting commands that can be transmitted to the lighting devices of the lighting system via data links are generated in the lighting control console; and
wherein a three-dimensional simulation of a light show that is controlled by the lighting control console can be calculated on a virtual stage in the simulation computer.

13. The system according to claim 12, wherein at least one display device of the lighting control console has a touch-sensitive sensing face, and wherein touching the touch-sensitive sensing face in the area of a contact surface on the display device can cause an operator input assigned to the respective contact surface to be selected and to be transmitted to the simulation computer as an operating command.

14. The system according to claim 13, wherein simultaneously touching the touch-sensitive sensing face of the display device in the area of a first contact surface to which a first operator input is assigned and in the area of a second contact surface to which a second operator input is assigned can be detected, and wherein both operator inputs can be transmitted to the simulation computer together as an operating command.

15. The system according to claim 13, wherein multiple keys may be displayed simultaneously as operating elements on the display device of the lighting control console with the touch-sensitive sensing face, one operator input being assigned to each key.

16. The system according to claim 14, wherein multiple keys may be displayed simultaneously as operating elements on the display device of the lighting control console with the touch-sensitive sensing face, one operator input being assigned to each key.

17. The system according to claim 13, wherein multiple slide controllers and/or rotary controllers can be displayed as operating elements on the display device of the lighting control console with the touch-sensitive sensing face, one adjustment range being assigned to each slide controller and/or rotary controller, and wherein the position of the contact surfaces on the various slide controllers and/or rotary controllers is detected cyclically, particularly at regular time intervals.

18. The system according to claim 14, wherein multiple slide controllers and/or rotary controllers can be displayed as operating elements on the display device of the lighting control console with the touch-sensitive sensing face, one adjustment range being assigned to each slide controller and/or rotary controller, and wherein the position of the contact surfaces on the various slide controllers and/or rotary controllers is detected cyclically, particularly at regular time intervals.

19. The system according to claim 15, wherein multiple slide controllers and/or rotary controllers can be displayed as operating elements on the display device of the lighting control console with the touch-sensitive sensing face, one adjustment range being assigned to each slide controller and/or rotary controller, and wherein the position of the contact surfaces on the various slide controllers and/or rotary controllers is detected cyclically, particularly at regular time intervals.

20. The system according to claim 12, wherein a second, internal simulation computer, with which a three-dimensional simulation of a light show controlled by the lighting control console can be calculated on a virtual stage, is provided in the housing of the lighting control console, wherein the light show calculated by the second simulation computer can be displayed on a display device of the lighting control console.

21. The system according to claim 13, wherein a second, internal simulation computer, with which a three-dimensional simulation of a light show controlled by the lighting control console can be calculated on a virtual stage, is provided in the housing of the lighting control console, wherein the light show calculated by the second simulation computer can be displayed on a display device of the lighting control console.

22. The system according to claim 14, wherein a second, internal simulation computer, with which a three-dimensional simulation of a light show controlled by the lighting control console can be calculated on a virtual stage, is provided in the housing of the lighting control console, wherein the light show calculated by the second simulation computer can be displayed on a display device of the lighting control console.

23. The system according to claim 15, wherein a second, internal simulation computer, with which a three-dimensional simulation of a light show controlled by the lighting control console can be calculated on a virtual stage, is provided in the housing of the lighting control console, wherein the light show calculated by the second simulation computer can be displayed on a display device of the lighting control console.

24. The system according to claim 17, wherein a second, internal simulation computer, with which a three-dimensional simulation of a light show controlled by the lighting control console (02) can be calculated on a virtual stage, is provided in the housing of the lighting control console (02), wherein the light show calculated by the second simulation computer can be displayed on a display device (10, 11, 12) of the lighting control console.

25. The system according to claim 20, wherein the external simulation computer and the internal simulation computer of the lighting control console can exchange data with each other via the input data line in order to synchronize the simulation calculation.

26. The system according to claim 21, wherein the external simulation computer and the internal simulation computer of the lighting control console can exchange data with each other via the input data line in order to synchronize the simulation calculation.

27. The system according to claim 22, wherein the external simulation computer and the internal simulation computer of the lighting control console can exchange data with each other via the input data line in order to synchronize the simulation calculation.

28. The system according to claim 23, wherein the external simulation computer and the internal simulation computer of the lighting control console can exchange data with each other via the input data line in order to synchronize the simulation calculation.

29. The system according to claim 24, wherein the external simulation computer and the internal simulation computer of the lighting control console can exchange data with each other via the input data line in order to synchronize the simulation calculation.

30. The system according to claim 12, wherein an electronic storage element is provided in the housing of the lighting control console, on which at least one configuration file is stored, wherein the configuration file at last partly describes the configuration of the lighting devices in the lighting system, and wherein the configuration data stored in the configuration file can be transmitted to the external simulation computer via the input data line, and wherein the configuration data is used in the simulation computer for calculating the light show that is controlled by the lighting control console on a virtual stage.

31. The system according to claim 13, wherein an electronic storage element is provided in the housing of the lighting control console, on which at least one configuration file is stored, wherein the configuration file at last partly describes the configuration of the lighting devices in the lighting system, and wherein the configuration data stored in the configuration file can be transmitted to the external simulation computer via the input data line, and wherein the configuration data is used in the simulation computer for calculating the light show that is controlled by the lighting control console on a virtual stage.

32. The system according to claim 14, wherein an electronic storage element is provided in the housing of the lighting control console, on which at least one configuration file is stored, wherein the configuration file at last partly describes the configuration of the lighting devices in the lighting system, and wherein the configuration data stored in the configuration file can be transmitted to the external simulation computer via the input data line, and wherein the configuration data is used in the simulation computer for calculating the light show that is controlled by the lighting control console on a virtual stage.

33. The system according to claim 15, wherein an electronic storage element is provided in the housing of the lighting control console, on which at least one configuration file is stored, wherein the configuration file at last partly describes the configuration of the lighting devices in the lighting system, and wherein the configuration data stored in the configuration file can be transmitted to the external simulation computer via the input data line, and wherein the configuration data is used in the simulation computer for calculating the light show that is controlled by the lighting control console on a virtual stage.

34. The system according to claim 17, wherein an electronic storage element is provided in the housing of the lighting control console, on which at least one configuration file is stored, wherein the configuration file at last partly describes the configuration of the lighting devices in the lighting system, and wherein the configuration data stored in the configuration file can be transmitted to the external simulation computer via the input data line, and wherein the configuration data is used in the simulation computer for calculating the light show that is controlled by the lighting control console on a virtual stage.

35. The system according to claim 20, wherein an electronic storage element is provided in the housing of the lighting control console, on which at least one configuration file is stored, wherein the configuration file at last partly describes the configuration of the lighting devices in the lighting system, and wherein the configuration data stored in the configuration file can be transmitted to the external simulation computer via the input data line, and wherein the configuration data is used in the simulation computer for calculating the light show that is controlled by the lighting control console on a virtual stage.

36. The system according to claim 25, wherein an electronic storage element is provided in the housing of the lighting control console, on which at least one configuration file is stored, wherein the configuration file at last partly describes the configuration of the lighting devices in the lighting system, and wherein the configuration data stored in the configuration file can be transmitted to the external simulation computer via the input data line, and wherein the configuration data is used in the simulation computer for calculating the light show that is controlled by the lighting control console on a virtual stage.

37. The system according to claim 30, wherein the configuration file contains configuration data for describing the arrangement of lighting devices on the stage.

38. The system according to claim 31, wherein the configuration file contains configuration data for describing the arrangement of lighting devices on the stage.

39. The system according to claim 32, wherein the configuration file contains configuration data for describing the arrangement of lighting devices on the stage.

40. The system according to claim 33, wherein the configuration file contains configuration data for describing the arrangement of lighting devices on the stage.

41. The system according to claim 34, wherein the configuration file contains configuration data for describing the arrangement of lighting devices on the stage.

42. The system according to claim 35, wherein the configuration file contains configuration data for describing the arrangement of lighting devices on the stage.

43. The system according to claim 36, wherein the configuration file contains configuration data for describing the arrangement of lighting devices on the stage.

44. The system according to claim 30, wherein the configuration file contains configuration data for describing the function parameters of the lighting devices.

45. The system according to claim 31, wherein the configuration file contains configuration data for describing the function parameters of the lighting devices.

46. The system according to claim 32, wherein the configuration file contains configuration data for describing the function parameters of the lighting devices.

47. The system according to claim 33, wherein the configuration file contains configuration data for describing the function parameters of the lighting devices.

48. The system according to claim 34, wherein the configuration file contains configuration data for describing the function parameters of the lighting devices.

49. The system according to claim 35, wherein the configuration file contains configuration data for describing the function parameters of the lighting devices.

50. The system according to claim 36, wherein the configuration file contains configuration data for describing the function parameters of the lighting devices.

51. The system according to claim 30, wherein the configuration file contains configuration data for describing three-dimensional objects on the stage.

52. The system according to claim 32, wherein the configuration file contains configuration data for describing three-dimensional objects on the stage.

53. The system according to claim 33, wherein the configuration file contains configuration data for describing three-dimensional objects on the stage.

54. The system according to claim 34, wherein the configuration file contains configuration data for describing three-dimensional objects on the stage.

55. The system according to claim 35, wherein the configuration file contains configuration data for describing three-dimensional objects on the stage.

56. The system according to claim 36, wherein the configuration file contains configuration data for describing three-dimensional objects on the stage.
